(19) United States
(12) Patent Application Publication
(10) Pub. No.: US 2025/0144797 A1
(43) Pub. Date: May 8, 2025

(54) FAST SETTLING FOR ROBOTIC MOTION CONTROL

(71) Applicant: FANUC AMERICA CORPORATION, Rochester Hills, MI (US)

(72) Inventors: Matthew DeNio, Clarkston, MI (US); Yi Sun, Bloomfield Hills, MI (US); Joseph Hoffman, Rochester Hills, MI (US)

(21) Appl. No.: 18/937,138

(22) Filed: Nov. 5, 2024

Related U.S. Application Data
(60) Provisional application No. 63/596,372, filed on Nov. 6, 2023.

(51) Int. Cl. B25J 9/16; B23K 26/38

(52) U.S. Cl. CPC B25J 9/1664; B23K 26/38

(57) ABSTRACT

A system and method for controlling movement of a robot holding a tool from an end of one tool operation to a beginning of a next tool operation that reduces tool jerk and thus reduces the robot stabilization time. The method includes separating the robot movement into a plurality of segments that have different robot movement accelerations, determining an acceleration of the robot for each segment that optimizes a cycle time of the robot movement, and reducing the optimal acceleration of the robot during a last segment so as to reduce tool jerk when the robot reaches the beginning of the next tool operation. In one non-limiting embodiment, the tool is a laser cutting tool and the number of segments is seven segments.

### CROSS-REFERENCE TO RELATED APPLICATIONS

This application claims the benefit of the filing date of U.S. Provisional Patent Application No. 63/596,372, titled FAST SETTLING FOR ROBOTIC MOTION CONTROL, filed Nov. 6, 2023.

### BACKGROUND

### Field

This disclosure relates generally to a system and method for reducing the settling time of a robot holding a tool at a robot movement destination and, more particularly, to a system and method for reducing the settling time of a robot holding a tool at a robot movement destination that includes reducing the acceleration of the robot only during a last segment of the movement operation.

### Discussion of the Related Art

Robots perform a number of tasks. One of those tasks is laser cutting of various parts. It is desirable from an efficiency standpoint to reduce the cycle time of the cutting operations as much as possible. Therefore, robotic laser cutting typically requires aggressive robot motion from, for example, the end of one cutting operation to the beginning of the next cutting operation to optimize the cycle time of the cutting operations. This aggressive robot motion often results in excessive vibration of the robot cutting tool at the stop location where the next cutting operation starts, referred to herein as tool jerk. This tool jerk has a direct impact on the quality of the cut and thus the shape of the part. Therefore, it is often necessary to provide a tool settling time so that tool jerk is reduced to an acceptable level when the tool reaches the stop location before the next cutting operation begins. This undesirably increases the cycle time of the cutting operations.

It is known to reduce the speed of movement of the cutting tool during the robot movement from the end of one cutting operation to the beginning of the next cutting operation, which reduces the tool vibration at the stop location, and thus reduces the amount of time required for tool settling. However, the slower robot speed during the robot movement also extends the cycle time of the cutting operations. Additionally, these movement operations require cycle tuning because the tool settling and stabilization time may be different for different parts, which requires longer robot teach times.

Stated differently, labor intensive and iterative techniques are sometimes employed to optimize robot move patterns for each cutting operation of the robot. The total part process time is equal to the robot move time plus the delay added to account for setting time and cut time. There is a balance between the programmed slowdown of the move time and the delay that makes finding the optimal performance a challenge, which often requires specialized technicians and programmers resulting in increased cost.

### SUMMARY

The following discussion discloses and describes a system and method for controlling movement of a robot holding a tool from an end of one tool operation to a beginning of a next tool operation that reduces tool jerk and thus reduces the robot stabilization time. The method includes separating the robot movement into a plurality of segments that have different robot movement accelerations, determining an acceleration of the robot for each segment that optimizes a cycle time of the robot movement, and reducing the optimal acceleration of the robot during a last segment so as to reduce tool jerk when the robot reaches the beginning of the next tool operation. In one non-limiting embodiment, the tool is a laser cutting tool and the number of segments is seven segments.

Additional features of the disclosure will become apparent from the following description and appended claims, taken in conjunction with the accompanying drawings.

### BRIEF DESCRIPTION OF THE DRAWINGS

FIG. 1 is an illustration of a robot system including a robot with a cutting tool;

FIG. 2 is a graph with time on the horizontal axis and tool position, tool velocity, tool acceleration and tool jerk on the vertical axis;

FIG. 3 is a graph with time on the horizontal axis and magnitude on the vertical axis showing tool velocity for an old technique for robot movement and a modified technique for robot movement;

FIG. 4 is a graph with time on the horizontal axis and magnitude on the vertical axis showing tool acceleration for the old technique for robot movement and the modified technique for robot movement;

FIG. 5 is a graph with time on the horizontal axis and magnitude on the vertical axis showing tool jerk for the old technique for robot movement and the modified technique for robot movement; and

FIG. 6 is a graph with time on the horizontal axis and tool vibration magnitude on the vertical axis showing robot stabilization for the old technique for robot movement and the modified technique for robot movement.

### DETAILED DESCRIPTION OF THE EMBODIMENTS

The following discussion of the embodiments of the disclosure directed to a system and method for reducing the settling time of a robot holding a tool at a robot movement destination is merely exemplary in nature, and is in no way intended to limit the disclosure or its applications or uses. For example, the discussion describes the tool as a laser cutting tool, but it could be other tool types.

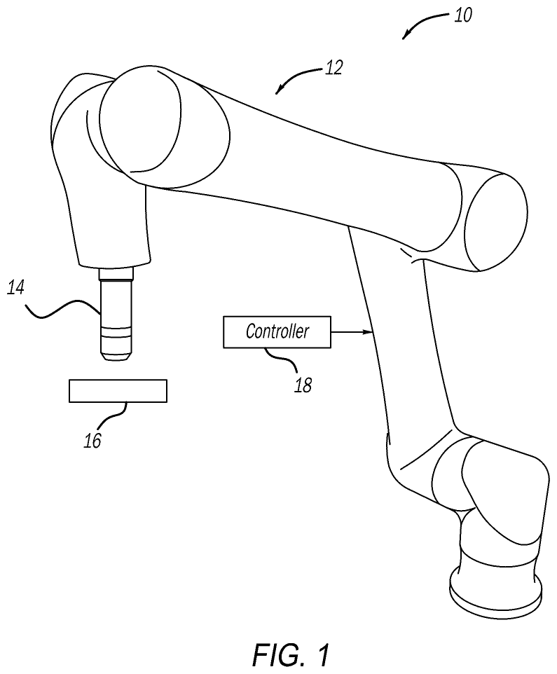

FIG. 1 is an illustration of a robot system 10 including a six-axis robot 12 holding a cutting tool 14 for performing a cutting operation on a part 16. The robot 12 is intended to represent any robot suitable for the purposes discussed herein. A controller 18 controls the robot 12 and is intended to represent all of the controllers and devices necessary to perform the various calculations and control the robot 12 in the manner discussed herein.

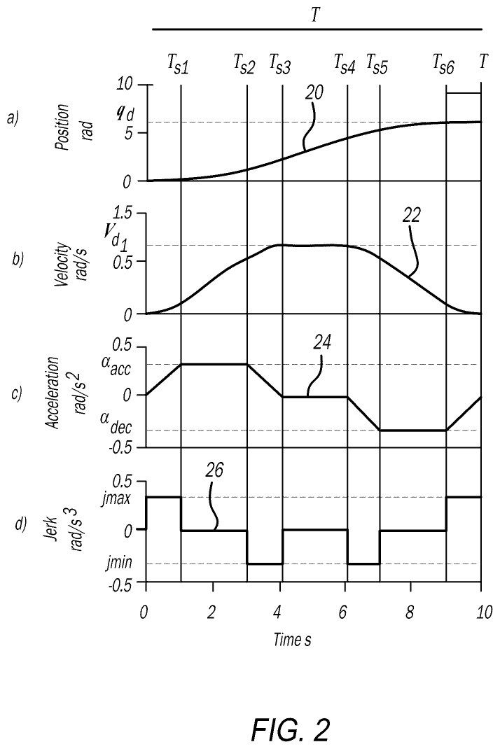

FIG. 2 is a graph with time on the horizontal axis and robot position, robot velocity, robot acceleration and tool jerk on the vertical axis illustrating a robot motion profile and profile characteristic of the robot 14 using an S-curve. This robot motion profile is intended to represent the optimal speed that the tool 14 can make from the location at the end of one cutting operation to the stop location at the beginning of the next cutting operation, sometimes referred to as an air cut. This robot motion profile would typically cause high tool vibrations or tool jerk at the end of the movement cycle, which would require a settling time to stabilize the tool 14 before the cutting operation proceeded.

The S-curve robot motion profile shown in FIG. 2 can be broken into seven segments, specifically a first segment between time 0 at the end location of the last cutting operation to time Tₛ₁, which is 1 second in this example; a second segment between time Tₛ₁ and time Tₛ₂, which is 2 seconds in this example; a third segment between time Tₛ₂ and time Tₛ₃, which is 1 second in this example; a fourth segment between time Tₛ₃ and time Tₛ₄, which is 2 seconds in this example; a fifth segment between time Tₛ₄ and time Tₛ₅, which is 1 second in this example; a sixth segment between time Tₛ₅ and time Tₛ₆, which is 2 seconds in this example; and a seventh segment between time Tₛ₆ and time T, which is 1 second in this example. This particular robot movement takes ten seconds. However, other robot movement operations will take other times, but will also be able to be broken down into seven segments.

A position graph line 20 shows the position of the tool 14 from the end location of the last cutting operation at time 0 to the beginning location of the next cutting operation at time 10 seconds.

A velocity graph line 22 shows the robot 12 increasing in velocity from 0 to about 4 seconds during the first three segments, then having a constant velocity for about 2 seconds during the fourth segment, and then slowing down for the last 4 seconds during the last three segments until it stops at time 10 seconds.

An acceleration graph line 24 shows the acceleration of the robot 12 to provide the robot speed profile of the graph line 22. Particularly, the robot acceleration is increasing from 0 to 1 second during the first segment, then the robot acceleration is constant from 1 to 3 seconds during the second segment, then the robot acceleration is decreasing from 3 to 4 seconds during the third segment, then the robot acceleration is constant from 4 to 6 seconds during the fourth segment, then the robot acceleration is decreasing from 6 to 7 seconds during the fifth segment, then the robot acceleration is constant from 7 to 9 seconds during the sixth segment, and then the robot acceleration is increasing from 9 to 10 seconds during the seventh segment.

A tool jerk graph line 26 shows the magnitude of tool jerk in response to changes in acceleration of the robot 12, where the slope of the graph line 24 determines the magnitude of the graph line 26, and where robot acceleration provides positive jerk and robot deceleration provides negative jerk. Based on the graph line 24, the graph line 26 has positive jerk from 0 to 1 second during the first segment, then no jerk from 1 to 3 seconds during the second segment, then negative jerk from 3 to 4 seconds during the third segment, then no jerk from 4 to 6 seconds during the fourth segment, then negative jerk from 6 to 7 seconds during the fifth segment, then no jerk from 7 to 9 seconds during the sixth segment, and then positive jerk from 9 to 10 seconds during the seventh segment.

This disclosure proposes a modified technique for robot movement to that shown in FIG. 2 that includes maintaining the desired robot acceleration during the first to sixth segments as described above to achieve a high robot cycle time during the robot movement, but reducing the acceleration of the robot 12 only during the seventh and last segment to an acceleration that reduces tool jerk so as to reduce the settling time required when the robot 12 stops moving before the tool 14 can begin its cutting operation at the new location. Reducing the robot acceleration in the seventh segment reduces the amplitude of the positive jerk of the graph line 26 in the seventh segment, but extends the time that it takes for the robot 12 to reach its destination. For example, instead of taking 1 second to move from the end of the sixth segment to the end of the seventh segment, it may take 2 seconds, which significantly reduces tool jerk when the robot 12 stops at the end of the seventh segment. Thus, the settling time is reduced for robot stabilization at the end of the move cycle to begin the next cutting operation. Since the seventh segment is only one second long and is a final deceleration section in the example discussed above, most of the robot movement cycle is at the desired optimal speed, and thus the entire cycle speed isn't significantly reduced.

Since there is minimal or reduced tool jerk when the robot 12 stops at the end of the seventh segment and thus there is a reduced stabilization settling time, the proposed or modified robot movement process having the reduction of robot acceleration during the seventh segment has a faster cycle time than the known technique of moving the robot as fast as possible, but waiting for the tool 14 to stabilize and settle at the end of the cycle. Further, since the proposed robot movement process maintains most of the desired robot speed during the move cycle, it has a faster cycle time than the known technique of reducing the speed of the robot 12 for the entire move cycle. Also, the specialized programming previously required for optimal robot movement to achieve the desired robot speed and stabilization wait time is reduced.

To perform the modified robot movement technique as described, the controller 18 separates the robot movement from the end of one tool operation to the beginning of the next tool operation into a plurality of robot movement segments that have different robot movement accelerations, where one of the robot movement segments is a last robot movement segment just before the beginning of the next tool operation. The controller 18 determines an optimal acceleration of the robot 12 for each robot movement segment that optimizes a cycle time of the robot movement in each robot movement segment, where the optimized cycle time is a predetermined maximum time. The controller 18 reduces the optimal acceleration of the robot 12 during the last robot movement segment to a less than optimal acceleration so as to reduce tool jerk when the robot reaches the beginning of the next tool operation.

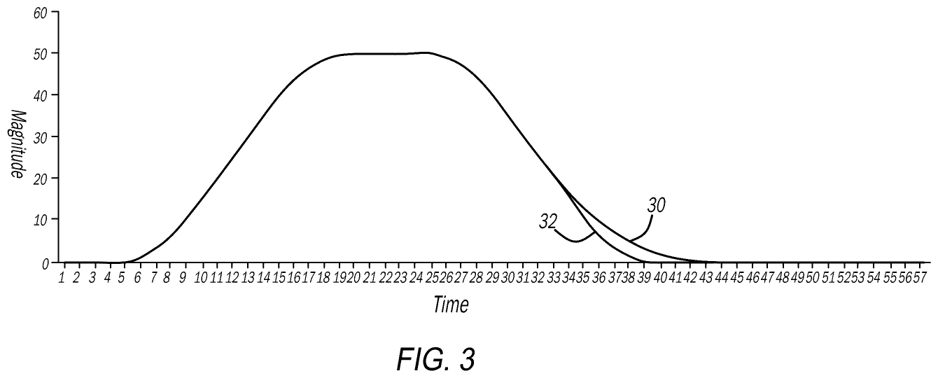

The following graphs illustrate the modified technique for robot movement as discussed above. FIG. 3 is a graph with time on the horizontal axis and magnitude on the vertical axis showing robot velocity. Graph line 30 is a representation of the graph line 22 shown in FIG. 2, but is different during the seventh segment. Particularly, for the modified technique described herein, the velocity of the robot 12 is the same as the velocity of the robot 12 illustrated in FIG. 2 except during the seventh segment. In this illustration, the seventh segment is longer for the graph line 30, specifically between points thirty-four and forty-two, where the robot 12 takes longer to slow down. For the graph line 22, the seventh segment is between points thirty-four and thirty-nine and is represented by graph line segment 32.

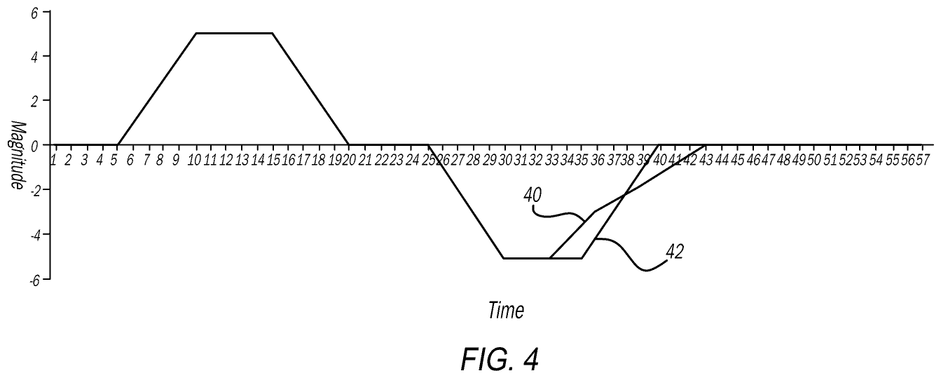

FIG. 4 is a graph with time on the horizontal axis and magnitude on the vertical axis showing robot acceleration. Graph line 40 is a representation of the graph line 24 shown in FIG. 2, but is different during the seventh segment. Particularly, for the modified technique described herein, the acceleration of the robot 12 is the same as the acceleration of the robot 12 illustrated in FIG. 2 except during the seventh segment. In this illustration, the seventh segment is longer for the graph line 40, specifically between points thirty-three and forty-three, where the robot 12 accelerates. For the graph line 24, the seventh segment is between points thirty-three and forty and is represented by graph line segment 42.

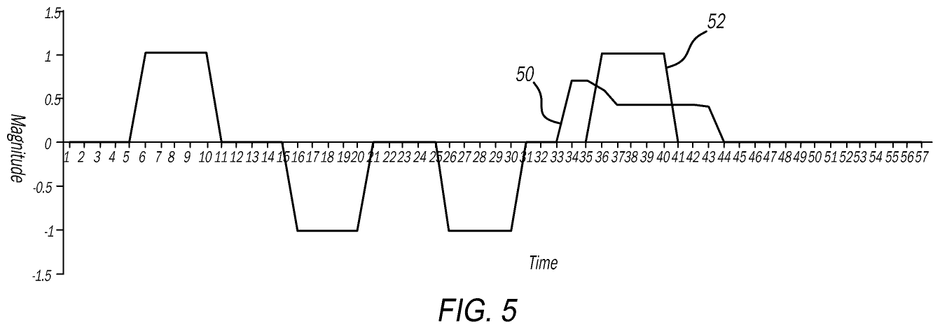

FIG. 5 is a graph with time on the horizontal axis and magnitude on the vertical axis showing tool jerk. Graph line 50 is a representation of the graph line 26 shown in FIG. 2, but is different during the seventh segment. Particularly, for the modified technique described herein, the tool jerk is the same as the tool jerk illustrated in FIG. 2 except during the seventh segment. In this illustration, the seventh segment is longer for the graph line 50, specifically between points thirty-three and forty-four. For the graph line 26, the seventh segment is between points thirty-five and forty-one and is represented by graph line segment 52.

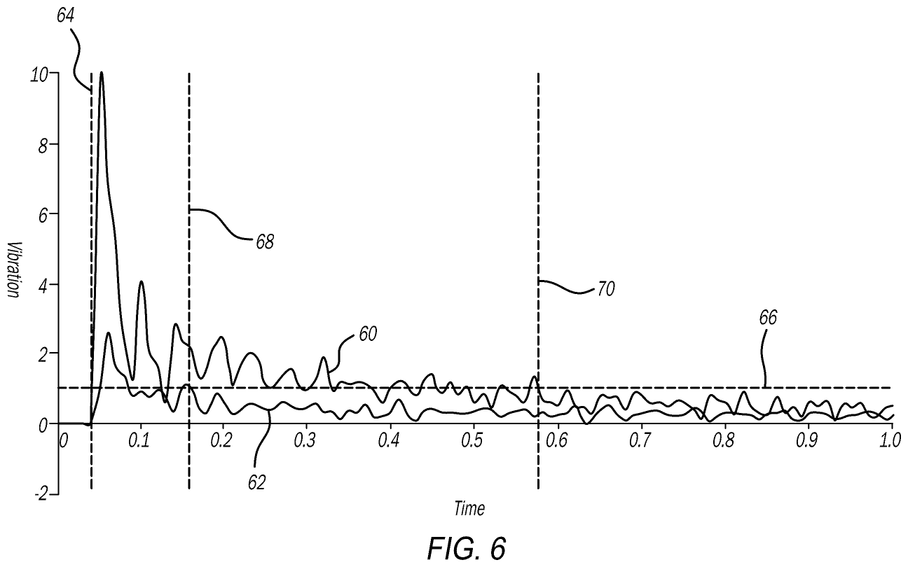

FIG. 6 is a graph with time on the horizontal axis and tool vibration magnitude on the vertical axis showing robot stabilization for the old technique for robot movement and the modified technique for robot movement. Graph line 60 shows robot stabilization for the old technique for robot movement and graph line 62 shows robot stabilization for the modified technique for robot movement. Line 64 represents the end of the seventh segment where the robot 12 stops to begin its next cutting operation. The robot movement for the modified technique would end later than the robot movement for the old technique, however, they are shown to occur at the same merely for illustration purposes. Line 66 represents the line showing where tool vibration is acceptable for a certain tool operation. Specifically, tool vibration above the line 66 is not acceptable and tool vibration below the line 66 is acceptable. As is apparent, the tool vibration becomes acceptable at time line 68 for the modified technique for robot movement, but does not become acceptable for the old technique for robot movement until time line 70. Therefore, even though the tool 14 reaches its destination faster for the old technique for robot movement than the modified technique for robot movement, the time that the tool 14 is available to begin the next cutting operation is longer for the old technique for robot movement than the modified technique for robot movement.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for controlling movement of a robot holding a tool from an end of one tool operation to a beginning of a next tool operation, said method comprising:
separating the movement of the robot from the end of the one tool operation to the beginning of the next tool operation into a plurality of robot movement segments that have different robot movement accelerations, wherein one of the robot movement segments is a last robot movement segment just before the beginning of the next tool operation;
determining an optimal acceleration of the robot for each robot movement segment that optimizes a cycle time of the robot movement in each robot movement segment, wherein the optimized cycle time is a predetermined maximum time; and
reducing the optimal acceleration of the robot during the last robot movement segment to a less than optimal acceleration so as to reduce tool jerk when the robot reaches the beginning of the next tool operation.

2. The method according to claim 1 wherein the plurality of robot movement segments is seven segments and the last robot movement segment is the seventh robot movement segment.

3. The method according to claim 1 wherein the robot tool is a laser cutting tool.

4. The method according to claim 1 wherein the last robot movement segment is a final deceleration section of the combined robot movement segments.

5. A method for controlling movement of a robot holding a laser cutting tool from an end of one tool operation to a beginning of a next tool operation, said method comprising:
separating the movement of the robot from the end of the one tool operation to the beginning of the next tool operation into seven robot movement segments that have different robot movement accelerations;
determining an optimal acceleration of the robot for each robot movement segment that optimizes a cycle time of the robot movement in each robot movement segment, wherein the optimized cycle time is a predetermined maximum time; and
reducing the optimal acceleration of the robot during the seventh robot movement segment to a less than optimal acceleration so as to reduce tool jerk when the tool reaches the beginning of the next tool operation.

6. The method according to claim 5 wherein the seventh robot movement segment is a final deceleration section of the combined robot movement segments.

7. A system for controlling movement of a robot holding a tool from an end of one tool operation to a beginning of a next tool operation, said system comprising a controller configured to separate the movement of the robot from the end of the one tool operation to the beginning of the next tool operation into a plurality of robot movement segments that have different robot movement accelerations, wherein one of the robot movement segments is a last robot movement segment just before the beginning of the next tool operation, determine an optimal acceleration of the robot for each robot movement segment that optimizes a cycle time of the robot movement in each robot movement segment, wherein the optimized cycle time is a predetermined maximum time, and reduce the optimal acceleration of the robot during the last robot movement segment to a less than optimal acceleration so as to reduce tool jerk when the robot reaches the beginning of the next tool operation.

8. The system according to claim 7 wherein the plurality of robot movement segments is seven segments and the last robot movement segment is the seventh robot movement segment.

9. The system according to claim 7 wherein the tool is a laser cutting tool.

10. The system according to claim 7 wherein the last robot movement segment is a final deceleration section of the combined robot movement segments.
